(19) United States
(12) Patent Application Publication
(10) Pub. No.: US 2005/0008489 A1
(43) Pub. Date: Jan. 13, 2005

(54) Antiwear device for a variable pitch system for a turbomachine vane

(75) Inventors: Philippe Perruchaut, Alfortville (FR); Christian Piekosz, Mennecy (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA MOTEURS, PARIS (FR)

(21) Appl. No.: 10/756,259

(22) Filed: Jan. 14, 2004

(30) Foreign Application Priority Data
Jan. 16, 2003 (FR) 03.00435

(51) Int. Cl. F03D 1/00

(52) U.S. Cl. 416/160

(57) ABSTRACT

A flexible link is hinged at a first end to a control ring and is fixed at a second end to a pivot for a vane that is to be controlled that is capable of turning in a smooth bearing passing through a portion of the body of a turbomachine. An insert ring constituted by a nickel- or cobalt-based metal material is interference fitted on the vane pivot, and the smooth bearing is made of a ceramic material.

### FIELD OF THE INVENTION

The present invention relates to controlling vanes having a variable pitch angle. The invention finds in particular an application in the field of aviation, in particular for controlling the angular positions of air inlet guide vanes in the compressors of turbomachines, such as turbojets or turboprops for aircraft.

### BACKGROUND OF THE INVENTION

Known devices for controlling variable pitch vanes in a turbomachine usually comprise a control member in the form of a ring surrounding a casing of the turbomachine together with a plurality of levers or links, each link having a first end connected to the control ring by a hinge and a second end mounted on a pivot of a corresponding vane.

The angular positions of all of the vanes are modified synchronously by turning the ring about the axis of the turbomachine. In order to be able to follow the turning movement of the ring, the connection between each link and the ring includes at least one degree of freedom in rotation about an axis directed substantially radially relative to the ring. Nevertheless, since the link is mounted rigidly on the pivot of the corresponding vane, turning the ring leads to other relative movements between the ring and the portion of the link that is mounted on the vane pivot.

In order to accommodate these additional movements, or at least some of them, it is well known to make the connection in the form of a ball-and-socket joint or an analogous part which, in addition to allowing turning about an axis that is substantially radial relative to the ring, also allows turning about an axis having a direction that is substantially circumferential relative to the ring. Nevertheless, since the use of ball-and-socket type joints or the like in a device for controlling a set of vanes or for controlling a plurality of sets of vanes simultaneously requires a large number of parts to be made at relatively great expense, the Applicant has already proposed in its French patent application No. FR 2 814 206 making a link as a laminated structure with ability to deform elastically in bending and in twisting that provides sufficient flexibility to avoid impeding the transmission of movement between the control ring and the vanes while simultaneously conserving sufficient thickness for the link to enable it to withstand fatigue and to avoid any risk of buckling. In addition, over the entire operating range of the control ring, there is no significant variation in resistance to deformation. The pitch of the vanes can thus be controlled accurately and easily.

That embodiment thus gives complete satisfaction. Nevertheless, in certain extreme conditions of use that depend on operating temperature, on contact pressure, on movement amplitude, or indeed on the environment, the stresses on the hinges expose the contacting surfaces to wear-type degradation that can spoil the general operation of the device, such degradation being particularly great since the device necessarily operates in a dry medium, i.e. it is not lubricated.

Proposals have also been made in patent EP 0 307 112 for a guide bearing for mounting on a vane pivot, where the bearing is constituted by a braided layer comprising a plurality of resin-impregnated strands to provide self-lubrication in the hinge. Nevertheless, in spite of that the bearing still presents a lifetime that is not very long.

U.S. Pat. No. 6,170,990 discloses a bushing for mounting on a vane pivot and made up of a plurality of superposed layers of graphite-based materials impregnated with resin on the friction side and based on resin-impregnated fibers on the casing side. However those materials serve essentially to prevent galvanic corrosion rather than wear.

### OBJECT AND SUMMARY OF THE INVENTION

An object of the invention is to avoid the damage due to wear phenomena at the hinge of the vane pivot in prior art devices by proposing a variable pitch vane control device capable of operating for considerably longer than those devices. Another object of the invention is to propose a device which remains operational regardless of the material used for making the vane.

These objects are achieved by a device of the type comprising a link, connection means forming a hinge between a first end of the link and a control ring, and means for fastening a second end of the link to a pivot of a vane that is to be controlled, the vane pivot being capable of turning in a smooth bearing passing through a portion of the body of the turbomachine, in which device, according to the invention, when said vane pivot is made of a nickel- or cobalt-based metal material, said smooth bearing is made of a ceramic material.

With this ceramic/metal pair, the lifetime of the device is greatly increased because of the lubricating role performed by the nickel or cobalt alloy oxides that are created during continuous contact between the vane pivot and the smooth bearing.

The ceramic material is preferably alumina (preferably alumina that is at least 97% pure, or better 99% pure). Said smooth bearing can then be made in two parts.

When the vane pivot is not constituted by a nickel- or cobalt-based metal material (but of a material made of titanium, for example), it is advantageous to provide an insert ring constituted by a nickel- or cobalt-based metal material that is engaged as an interference fit on said vane pivot. The insert ring may comprise two parts.

In an alternative embodiment, said insert ring made of a nickel- or cobalt-based metal material is replaced by a deposit of ceramic material on said vane pivot, and said smooth bearing constituted by a ceramic material is replaced by a smooth bearing constituted by a nickel- or cobalt-based metal material. The ceramic material is advantageously alumina and deposition is performed by plasma sputtering.

### BRIEF DESCRIPTION OF THE DRAWING

The invention will be better understood on reading the following description given by way of non-limiting indication and made with reference to the accompanying drawing, in which:

FIG. 1 is a section view of a conventional variable pitch vane control device;

FIG. 2 is a section view of a first embodiment of a bearing in accordance with the invention; and

FIG. 3 is a section view of a second embodiment of a bearing in accordance with the invention.

### DETAILED DESCRIPTION OF THE PREFERRED EMBODIMENTS

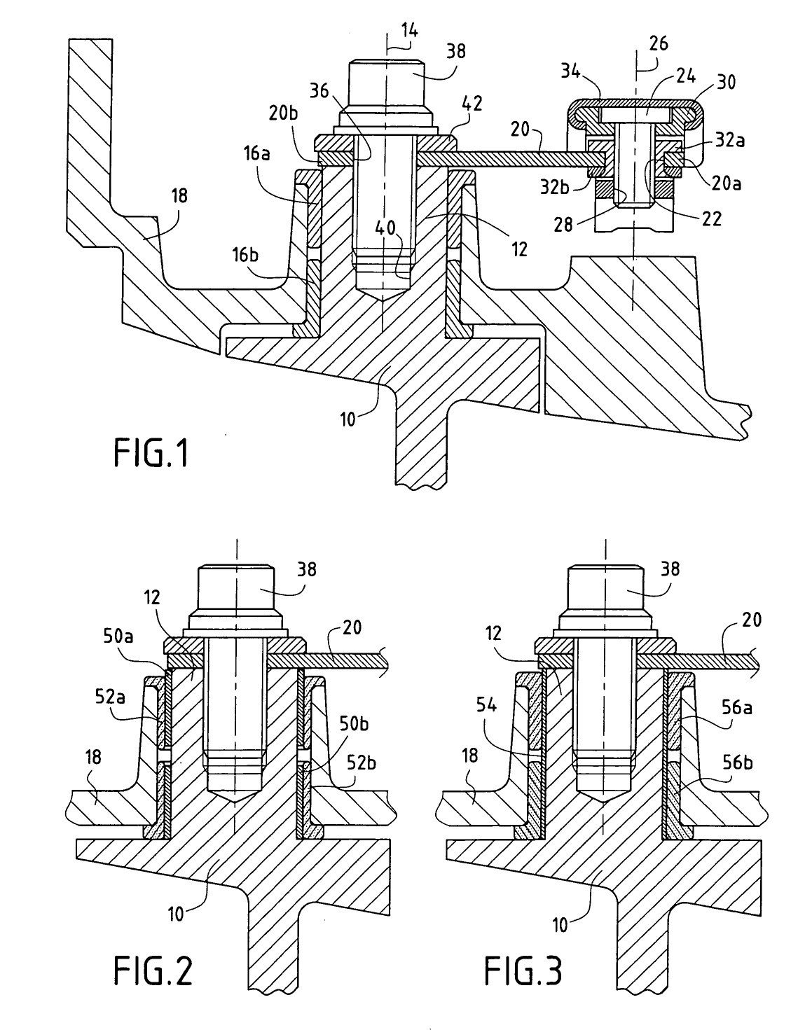

FIG. 1 is a section view through a portion of a turbomachine, a turbojet or a turboprop for aircraft or any other land-based or sea-based generator, showing by way of example one of the variable pitch guide vanes 10 that are distributed around the axis of such a machine and that are located at the inlet to its compressor.

Each vane 10 is provided with a vane pivot 12 of axis 14 capable of turning inside a smooth bearing defined by a two-part ring 16a, 16b passing through a portion of the body 18 of the turbomachine (specifically an outer shroud or the stator casing).

The angular position (pitch) of each vane 10 is varied by a flexible link 20 preferably comprising a flexible composite structure such as a laminated structure constituted by thin layers of metal alternating with layers of elastomer, the layers being bonded to one another as taught in above-cited French patent application No. 2 814 206. The metal layers are formed by sheets of metal of thickness that is preferably less than 0.5 millimeters (mm) cut out from foils or strips made of steel, stainless steel, or any other metal suitable for the intended application, for example. Similarly, the elastomer layers are formed by way of example out of natural rubber, chloroprene, butadiene, nitrile rubber, epichlorhydrine, silicone, etc., with selection being performed as a function of the desired mechanical characteristics and of operating conditions.

A first end 20a of the link 20 has a first orifice 22 for receiving connection means formed by a peg 24 of axis 26 engaged in a radial housing 28 of a control ring 30. This housing is advantageously defined by a bushing 32 (an assembly comprising two crimped-together parts, a sleeve 32a and a ring 32b) mounted in the first orifice 22 formed through the link 20 and intended firstly to compensate for slack between the link and the control ring, and secondly to provide a centering length that is sufficient to accommodate the forces on the peg 26. The peg is held in position by a locking ring 34 sliding on the control ring and provided with windows (not shown) of shape corresponding to the shape of the peg (or more precisely of its head).

A second end 20b opposite from the first end of the link 20 has a second orifice 36 for receiving means for fixing to the vane pivot 12. In the examples shown, this is achieved by a fastening screw 38 engaged in a tapped blind hole 40 in the vane pivot 12, however any other method of fastening could naturally be envisaged. The link is constrained to turn with the pivot 12 and it is held without slack in the vane pivot by being engaged, for example, in a radial groove (not shown), with the width of the groove being less than the width of the link, said groove being formed in the pivot and defining a seat for the link and two flat radial edges for positioning purposes. An abutment-forming washer 42 is interposed between the end 20b of the link and the fastening screw 38.

The control ring 30 whose axis coincides with the longitudinal axis of the turbomachine is capable of being turned about its axis. By way of example, it has a plurality of radially-pierced slots (not shown), the number of slots being equal to the number of vanes, and the slots being of width that is perceptibly greater than the width of a link. The ring is preferably made up of two parts (two half-rings) each occupying 180° of the circumference of the turbomachine. These parts are connected (locked) together by a bonding ferrule (not shown). The ring is turned in conventional manner by one or more actuators (not shown). By turning the control ring it is possible to vary the angular position (pitch) of the vanes 10 via the links 20. Similarly, the locking ring 34 is made up of two parts, each likewise occupying 180°. A single unit occupying 360° would naturally be possible, depending on the architecture of the turbomachine.

Conventionally, the portion of the turbomachine body 18 (stator casing, for example) is made of steel and the vanes, and in particular the vane pivots 12, are likewise made of steel or of titanium, for example.

Also, in a first embodiment of the invention as shown in FIG. 2, the vane pivot 12 is covered by a two-part insert ring 50a, 50b of the interference fit type constituted by a metal alloy selected from nickel- or cobalt-based metal materials, and the two-part smooth bearing 52a, 52b is made of a ceramic material, preferably alumina (Al₂O₃) of purity greater than 97%, and preferably greater than 99%.

The pair obtained in this way comprising an alumina ceramic and a nickel- or cobalt-based metal pair forms an extraordinary solution for combating wear that is particularly effective, especially at high temperature. It is accepted that ceramics have antiwear characteristics that are known for providing uniform contact in a lubricated medium, in particular for medical applications, but that they are ill-suited to contact without lubrication.

It has been found in the invention that the conductivity of the ceramic is low enough for the local friction temperatures to be capable of generating nickel or cobalt alloy oxides at the ceramic/metal interface and that these oxides act as a dry lubricant in the contact between the bearing and the vane pivot, thereby avoiding the premature wear which otherwise leads to degraded operation of the hinge.

Naturally, it is equally possible to use the inverse configuration as shown in FIG. 3, where alumina is deposited on the vane pivot 12 (preferably by plasma sputtering), this layer 54 deposited on the outside coming directly into contact with a two-part smooth bearing 56a, 56b which is then made of a metal alloy based on nickel or cobalt.

Finally, it may be observed that if the vane pivot 12 is constituted by a metal material based on nickel or cobalt, mere use of a smooth bearing made of ceramic material (without using any additional hooping) suffices to provide the looked-for ceramic/metal pair for solving the initially-raised technical problem of contact wear in continuous operation without liquid lubrication. It should also be observed that although the examples shown have rings made up of two parts (for ease of assembly), it is clear that one-part rings could equally well be envisaged.

1. A device for controlling a variable pitch vane in a turbomachine, the device comprising a link, connection means forming a hinge between a first end of the link and a control ring, and means for fastening a second end of the link to a pivot of a vane that is to be controlled, the vane pivot being capable of turning in a smooth bearing passing through a portion of the body of the turbomachine, wherein, when said vane pivot is made of a nickel- or cobalt-based metal material, said smooth bearing is made of a ceramic material.

2. A device according to claim 1, wherein said ceramic material is alumina.

3. A device according to claim 2, wherein said alumina is at least 97% pure.

4. A device according to claim 3, wherein said alumina is at least 99% pure.

5. A device according to claim 1, wherein said smooth bearing is made up of two parts.

6. A device according to claim 1, in which said vane pivot is not constituted by a nickel- or cobalt-based metal material, the device further comprising an insert ring constituted by a nickel- or cobalt-based metal material engaged as an interference fit on said vane pivot.

7. A device according to claim 6, wherein said insert ring is made up of two parts.

8. A device according to claim 6, wherein said insert ring made of a nickel- or cobalt-based metal material is replaced by a deposit of ceramic material on said vane pivot and said smooth bearing constituted by a ceramic material is replaced by a smooth bearing constituted by a nickel- or cobalt-based metal material.

9. A device according to claim 8, wherein said ceramic material is alumina.

10. A device according to claim 9, wherein said alumina is deposited by plasma sputtering.
